(19) United States
(12) Patent Application Publication
(10) Pub. No.: US 2004/0136173 A1
(43) Pub. Date: Jul. 15, 2004

(54) Surface light source device for liquid crystal display

(76) Inventor: Kun-Jung Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/744,164

(22) Filed: Dec. 22, 2003

(30) Foreign Application Priority Data
Dec. 20, 2002 (TW) 91136973

(51) Int. Cl. F21V 7/04

(52) U.S. Cl. 362/31

(57) ABSTRACT

A surface light source device providing illumination for a liquid crystal display panel includes a plurality of light sources (51) for emitting light beams, and an LGP (52) for transmitting the light beams. The LGP includes a light incident surface (523) for receiving the light beams, an emission surface (521) adjacent to the light incident surface for emitting the light beams, a bottom surface (522) opposite to the emission surface, and a plurality of diffusion dots (56) formed on the bottom surface for scattering the light beams. An area of each diffusion dot is inversely proportional to the sum of squares of distances between the diffusion dot and each of the light sources. The systematically varying areas of the diffusion dots enable the surface light source device to provide highly uniform illumination.

### BACKGROUND OF THE INVENTION

1. Field of the Invention

The present invention relates to a surface light source device typically used in a liquid crystal display (LCD), and especially to a surface light source device with highly uniform illumination.

2. Description of Prior Art

Recently, color liquid crystal display devices have been widely used in various applications, such as in portable personal computers, liquid crystal display televisions, video built-in type liquid crystal televisions, etc. A conventional liquid crystal display device comprises a back light unit or a surface light source device, and a liquid crystal panel. An under-lighting system or an edge-lighting system is used as the surface light source device. In an under-lighting system, a light source is disposed under a diffusion board, and the diffusion board is disposed under the liquid crystal panel. In an edge-lighting system, a light source is disposed at a side surface of a light guide plate (LGP), and the LGP is disposed under the liquid crystal panel.

Typically, an edge-lighting system includes an LGP and a light source. The LGP is formed from a planar transparent member such as an acrylic resin plate or the like. Light beams emitted from the light source are transmitted through a side surface (light incident surface) of the LGP into the LGP. Most of the incident light beams are internally reflected in the LGP between a light emission surface and a bottom surface of the LGP, and then transmitted more or less uniformly out through the light emission surface of the LGP. A multiplicity of light reflection dots having a light scattering function is formed on the bottom surface, to increase the uniformity of illumination of the surface light source device. The light source is usually a linear source such as a cold cathode fluorescent lamp (CCFL), or a point source such as a light emitting diode (LED).

The configuration of the reflection dots is key to good optical performance of the LGP. Thus, various configurations of reflection dots of LGPs have been devised recently. FIGS. 9 and 10 show a conventional surface light source device as disclosed in U.S. Pat. No. 5,363,294 issued on Nov. 8, 1994. The surface light source device includes an LGP 22, a CCFL 21, a reflection sheet 25, a prism 27, and three reflectors 29 (only one shown). The LGP 22 has a light incident surface 223, a bottom surface 222, an emission surface 221, and three side surfaces 224, 225. The CCFL 21 is arranged adjacent to the light incident surface 223. The reflection sheet 25 is placed under the bottom surface 222. The prism 27 is set above the emission surface 221. One of the reflectors 29 is arranged adjacent to the side surface 224. The other two reflectors 29 are arranged respectively adjacent to the two side surfaces 225. A multiplicity of diffusion dots 26 is provided on the bottom surface 222, arranged in a generally regular array of rows and columns. The diffusion dots 26 are arranged such that sizes thereof in a first main region A of the bottom surface 222 increase with increasing distance away from the CCFL 21, and sizes thereof in a second region B of the bottom surface 222 adjacent to the side surface 224 are the same. The sizes of the diffusion dots 26 in region B are substantially the same as a size of those diffusion dots 26 in region A that are adjacent region B. The diffusion dots 26 in any column of the array parallel to the CCFL 21 have a same size.

Generally, light intensity in region A decreases with increasing distance away from the CCFL 21. Thus the configuration of the diffusion dots 26 in region A can increase uniformity of illumination on the emission surface 221 of the LGP 22, because the intensity of light beams emitting from the emission surface 221 is substantially proportional to sizes of corresponding diffusion dots 26.

However, illumination in both regions A and B is uneven. One reason for this is because light beams are reflected by the reflector 29 that is distal from region A back into region B, and the columns of the diffusion dots 26 in region B are spaced different distances from that reflector 29. That is, the diffusion dots 26 in respective different columns in region B receive light beams having different intensities. Therefore light beams do not emit uniformly from the part of the emission surface 221 corresponding to region B. In other words, the uniformity of the diffusion dots 26 in region B causes non-uniform illumination of the emission surface 221 of the LGP 22. Another reason is that operation of the two reflectors 29 that are adjacent to the two side surfaces 225 has a similar effect to the above-described operation of the reflector 29 that is distal from region A. This results in uneven illumination between the side surfaces 225 in both regions A and B. Therefore light beams do not emit uniformly from the part of the emission surface 221 corresponding to both regions A and B; that is, the entire emission surface 221 of the LGP 22. In summary, the respective distributions of the diffusion dots 26 in regions A and B result in non-uniform illumination over the whole emission surface 221 of the LGP 22.

Furthermore, if the CCFL 21 is replaced by a series of point sources such as LEDs, the uniformity of illumination of the surface light source device is generally unsatisfactory. That is, the limited lighting characteristics of the LEDs result in a plurality of darker areas being created in the LGP 22 generally between each two adjacent LEDs. In conclusion, it is very problematic to provide even illumination throughout the entire emission surface 221 of the LGP 22.

Therefore, a surface light source device that overcomes the above-mentioned problems is desired.

### SUMMARY OF THE INVENTION

An object of the present invention is to provide a surface light source device with highly uniform illumination for a liquid crystal display, the surface light source device being able to employ a choice of one or more point or linear light sources.

To achieve the above object, a surface light source device of one embodiment of the present invention includes a plurality of light sources for emitting light beams, and an LGP. The LGP is for transmitting the light beams, and includes a light incident surface for receiving the light beams, an emission surface adjacent to the light incident surface for emitting the light beams, a bottom surface opposite to the emission surface, and a plurality of diffusion units formed on the bottom surface for scattering the light beams. An area of each diffusion unit is inversely proportional to the sum of squares of distances between the diffusion unit and each of the light sources. The systematically varying areas of the diffusion dots enable the surface light source device to provide highly uniform illumination.

Various other alternative embodiments are described. In some of these alternative embodiments, an area of each diffusion unit is calculated on a different basis to that described above.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a simplified, bottom elevation of a first embodiment of the surface light source device according to the present invention, the surface light source device comprising a line of point light sources, a light guide plate, and a plurality of reflective films coated on corresponding side surfaces of the light guide plate;

FIG. 2 is a side elevation of the surface light source device of FIG. 1;

FIG. 3 is a schematic, reduced view of the light guide plate of FIG. 1, showing the light guide plate located in a Cartesian coordinate system, and showing location points of the light sources and of images of the light source device formed by the reflective films;

FIG. 4 is a side elevation of a second embodiment of the surface light source device according to the present invention;

FIG. 5 is a bottom elevation of a third embodiment of the surface light source device according to the present invention;

FIG. 6 is a side elevation of the surface light source device of FIG. 5;

FIG. 7 is a side elevation of a fourth embodiment of the surface light source device according to the present invention;

FIG. 8 is a side elevation of a fifth embodiment of the surface light source device according to the present invention;

FIG. 9 is a side elevation of a conventional surface light source device; and

FIG. 10 is a bottom elevation of the surface light source device of FIG. 9.

### DETAILED DESCRIPTION OF THE INVENTION

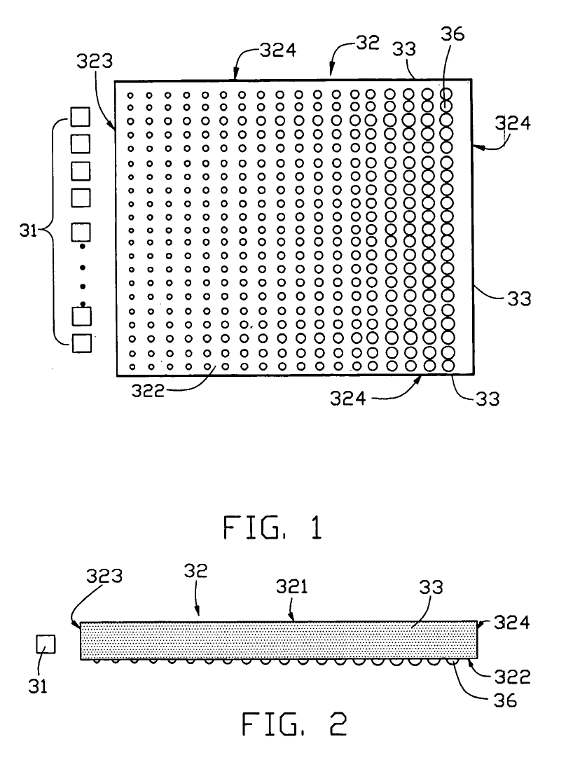

Referring to FIG. 1, a first embodiment of a surface light source device according to the present invention includes a plurality of point light sources 31 arranged in a line, an LGP 32 used to transmit light received from the point light sources 31, and three reflective films 33. The point light sources 31 can be light emitting diodes (LEDs) or like apparatuses. Alternatively, because a linear light source such as a CCFL can be regarded as a combination of innumerable LEDs, the point light sources 31 can be replaced by a CCFL. For this reason, where any embodiments of surface light source devices according to the present invention described below include a line of LEDs as light sources, such embodiments can alternatively employ a CCFL as a light source.

Referring to FIG. 2, the LGP 32 is a rectangular, transparent plate, and includes a light incident surface 323, three side surfaces 324, a top emission surface 321 perpendicular to the light incident surface 323 and the side surfaces 324, and a bottom surface 322 opposite to the emission surface 321. A multiplicity of diffusion dots 36 is formed on the bottom surface 322. A thickness of the LGP 32 is preferably in the range from approximately 1 millimeter to 10 millimeters. The point light sources 31 are disposed adjacent to the light incident surface 323. The reflective films 33 are coated on the side surfaces 324 respectively.

Transparent glass material or synthetic resin may be used to make the LGP 32. Various kinds of highly transparent synthetic resins may be used, such as acrylic resin, polycarbonate resin, vinyl chloride resin, etc. The selected resin may be molded into a plate using known molding methods such as extrusion molding, injection molding, or the like. In particular, polymethyl methacrylate (PMMA) resin provides excellent light transmission, heat resistance, dynamic characteristics, molding performance, processing performance, etc. It is especially suitable as a material for the LGP 32.

The diffusion dots 36 are generally hemispherical. That is, a bottom elevation of each diffusion dot 325 is circular, the circle defining an area (see below). In alternative embodiments, the diffusion dots 36 may be generally sub-hemispherical, cylindrical, parallelepiped-shaped, pyramidal or frustum-shaped. The diffusion dots 36 are arranged convexly on the bottom surface 322 in a generally uniform array of rows and columns. The diffusion dots 36 are formed by means of an integral molding technique; i.e., the diffusion dots 36 are formed integrally with the LGP 32.

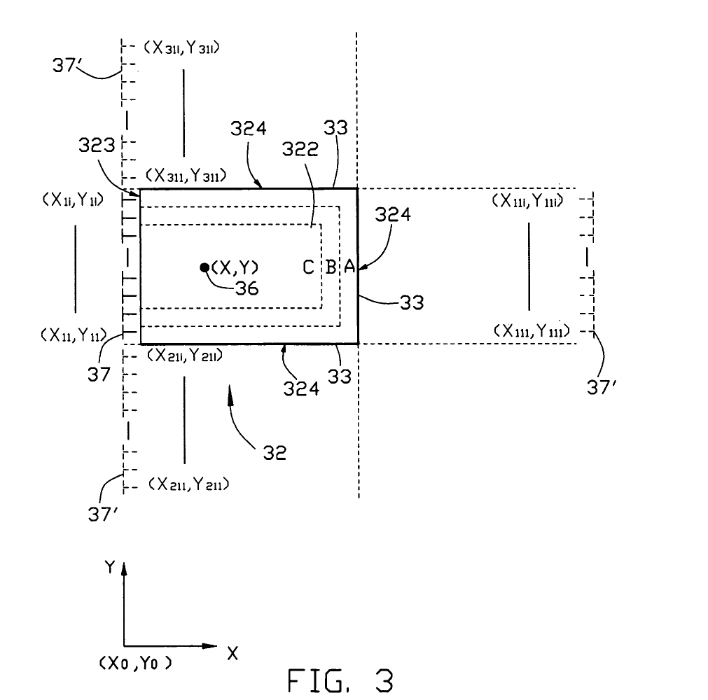

Referring also to FIG. 3, the area of each diffusion dot 36 is proportional to the sum of reciprocals of squares of distances between the diffusion dot 36 and each of the light sources 31, and the sum of reciprocals of squares of distances between the diffusion dot 36 and corresponding images of each of the light sources 31 formed by the side surfaces 324. This relationship is expressed by the following equation:

$$R = {r}_{0} + k \sqrt{ \begin{matrix}{\sum }_{h = 1}^{w - m} {\sum }_{j = 1}^{m} {\sum }_{i = 1}^{{n}_{i}} {f}_{h} \frac{1}{{( X - {X}_{hji} )}^{2} + {( Y - {Y}_{hji} )}^{2}} + \\ {\sum }_{j = 1}^{m} {\sum }_{i = 1}^{{n}_{j}} \frac{1}{{( X - {X}_{ji} )}^{2}} + {( Y - {Y}_{ji} )}^{2}\end{matrix} }$$

where R designates the radius of the diffusion dot 36; (X, Y), (Xⱼᵢ, Yⱼᵢ) and (Xₕⱼᵢ, Yₕⱼᵢ) respectively designate coordinates of the diffusion dot 36, locations 37 of the light sources 31 (see FIGS. 2 and 3), and locations 37′ of the images of the light sources 31 in a Cartesian coordinate system; w designates the number of side surfaces 324; m designates the number of light incident surfaces 323; nⱼ designates the number of light sources 31; fₕ designates the reflectivity of a corresponding side surface 324; i and j each designate the series of integers 1, 2, 3, . . . ; h designates a positive integer; and r₀ and k are constants whose values are related to predetermined specifications of the LGP 32, the light sources 31 and the locations 37 of the light sources 31.

In FIG. 3, a distribution of the diffusion dots 36 in region A on the bottom surface 322 can provide even illumination on the corresponding emission surface 321. This is because the diffusion dots 36 in region A are configured not only to be different in size, but also to take into account the fact that different locations in region A having different light intensities. In particular, an intensity of light beams received from the light sources 31 in region A decreases with increasing distance from the light sources 31, therefore sizes of the diffusion dots 36 in region A are configured to generally substantially increase with increasing distance from the light sources 31. In addition, an intensity of light beams received from the reflective films 33 in region C decreases with increasing distance from the reflective films 33, therefore sizes of the diffusion dots 36 in region C are also configured to generally increase with increasing distance from the reflective films 33. This blending of configuring of sizes of the diffusion dots 36 provides a result over and above the known advantages of the art of configuring diffusion dots relative to the light sources 31. Furthermore, an intensity of light beams received from the light sources 31 in region C decreases with increasing distance from the light sources 31, therefore sizes of the diffusion dots 36 in region C are configured to increase with increasing distance from the light sources 31. Region B can be considered as a kind of hybrid region interconnecting regions A and C. Thus sizes of the diffusion dots 36 in region B are the largest out of all the three regions A, B, C. Moreover, the present invention enables the surface light source device to illuminate uniformly even though the discrete point light sources 31 are used, rather than a linear light source such as a CCFL. This is because sizes of those diffusion dots 36 in any of regions A, B, C generally between two adjacent light sources 31 are configured to be larger than sizes of those diffusion dots 36 in any of regions A, B, C directly opposite the light sources 31. Thus an overall uniform distribution of light intensity on the emission surface 321 of the LGP 32 is attained.

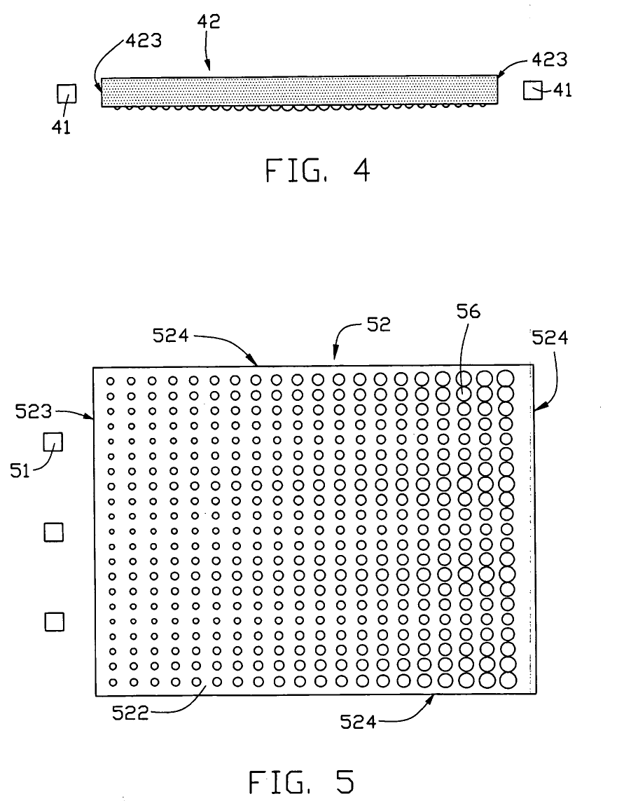

FIG. 4 shows a second embodiment of a surface light source device of the present invention. The surface light source device of the second embodiment is similar to the surface light source device of the first embodiment, except that the surface light source device of the second embodiment includes two lines of point light sources 41 located respectively at two opposite side surfaces 423 of an LGP 42.

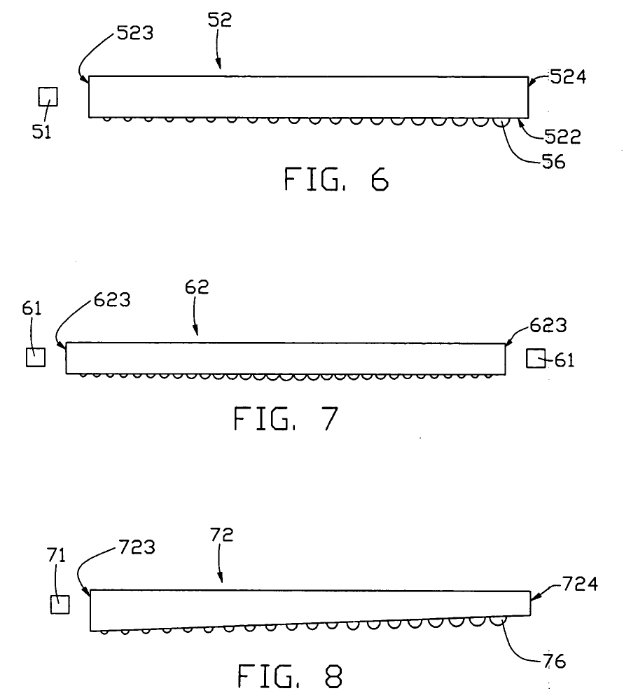

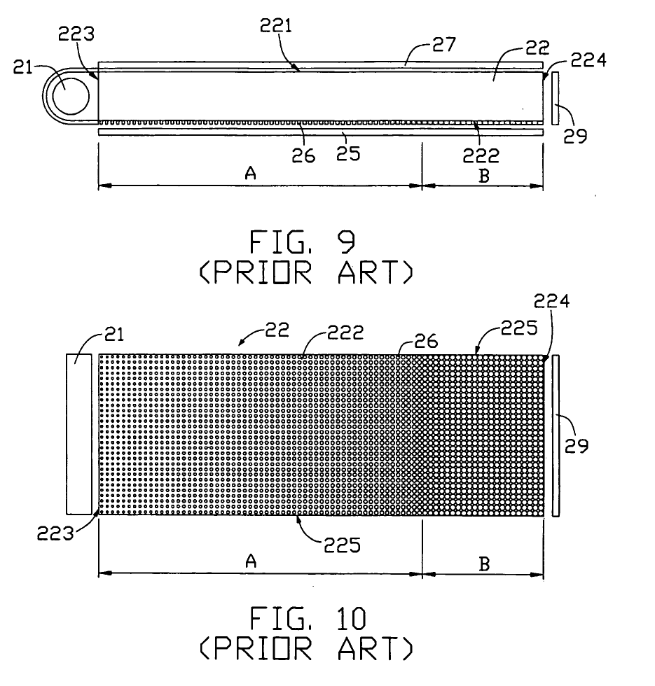

FIGS. 5 and 6 are views of a third embodiment of a surface light source device of the present invention. The surface light source device of the third embodiment is similar to the surface light source device of the first embodiment. Regardless of whether or not a plurality of reflective films is coated respectively on a plurality of corresponding side surfaces 524, a configuration of each of diffusion dots 56 is calculated according to the following equation:

$$R = {r}_{0} + k \sqrt{{\sum }_{i = 1}^{n} \frac{1}{{( X - {X}_{i} )}^{2} + {( Y - {Y}_{i} )}^{2}}}$$

where R designates the radius of the diffusion dot 56; (X, Y) and (Xᵢ, Yᵢ) respectively designate coordinates of the diffusion dot 56 and locations of the light sources 51 in a Cartesian coordinate system; n designates the number of light sources 51; i designates the series of integers 1, 2, 3, . . . ; and r₀ and k are constants whose values are related to predetermined specifications of the LGP 52, the light sources 51 and the locations of the light sources 51.

FIG. 7 is view of a fourth embodiment of a surface light source device of the present invention. The surface light source device of the fourth embodiment is similar to the surface light source device of the third embodiment, except that the surface light source device of the fourth embodiment includes two lines of point light sources 61 located respectively at two opposite side surfaces 623 of an LGP 62.

FIG. 8 is view of a fifth embodiment of a surface light source device of the present invention. The surface light source device of the fifth embodiment is similar to the surface light source device of the third embodiment, except that an LGP 72 is wedge-shaped. Sizes of a multiplicity of diffusion dots 76 increase with increasing distance from a thick end 723 of the LGP 72 to a thin end 724 of the LGP 72.

Further, a plurality of other embodiments of the surface light source device according to present invention can be configured. For example, the diffusion dots may be arranged in staggered rows, such that any diffusion dot in any row is located generally between two nearest diffusion dots in an adjacent row. Further or alternatively, the diffusion dots may be arranged in staggered columns in similar fashion. The diffusion dots may be parallelepiped-shaped, cylindrical, pyramidal, or frustum-shaped. The diffusion dots may be concavities, and may be arranged randomly on the bottom surface of the light guide plate. The diffusion dots may be formed by means of printing, using a pale or white ink containing a white pigment such as titanium oxide. The diffusion dots may alternatively be made by a mechanical shot blasting technique, a photo-sensing method using sensitized paper, an integral molding technique, or any other appropriate known method. The diffusion dots may be configured to be uniform in size, but having a density of distribution that increases with increasing distance away from the point light sources. This can achieve uniformity of light beam emission from the emission surface which is similar to that described above.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A surface light source device comprising:
a plurality of light sources for emitting light beams; and
a light guide plate (LGP) for transmitting the light beams, comprising:
a light incident surface for receiving the light beams;
an emission surface adjacent to the light incident surface for emitting the light beams;
a bottom surface opposite to the emission surface; and
a plurality of diffusion units formed on the bottom surface for scattering the light beams;
wherein an area of each diffusion unit is inversely proportional to the sum of squares of distances between the diffusion unit and each of the light sources.

2. The surface light source device as claimed in claim 1, wherein a radius R of each diffusion unit is represented by the following equation:
$$R = {r}_{0} + k \sqrt{{\sum }_{i = 1}^{n} \frac{1}{{( X - {X}_{i} )}^{2} + {( Y - {Y}_{i} )}^{2}}}$$
wherein (X, Y) and (Xᵢ, Yᵢ) respectively designate coordinates of the diffusion unit and the light source in a Cartesian coordinate system; n designates the number of light sources; i designates the series of integers 1, 2, 3, . . . ; and r₀ and k are constants whose values are related to predetermined specifications of the LGP and the light sources and locations of the light sources.

3. The surface light source device as claimed in claim 1, wherein each diffusion unit is generally hemispherical, sub-hemispherical, cylindrical, parallelepiped-shaped, pyramidal or frustum-shaped.

4. The surface light source device as claimed in claim 1, wherein the diffusion units are a convex protrusions or concavities or a combination thereof.

5. The surface light source device as claimed in claim 1, wherein the diffusion units are arranged in a generally uniform array on the bottom surface.

6. The surface light source device as claimed in claim 1, wherein the diffusion units are arranged randomly on the bottom surface.

7. The surface light source device as claimed in claim 1, wherein the diffusion units are integrally formed with the LGP, or are formed by printing.

8. The surface light source device as claimed in claim 1, wherein the LGP has a uniform thickness or is wedge-shaped.

9. The surface light source device as claimed in claim 1, wherein the LGP is made of polymethyl methacrylate (PMMA).

10. The surface light source device as claimed in claim 1, wherein the light sources are point light sources.

11. The surface light source device as claimed in claim 10, wherein the light sources are light emitting diodes.

12. The surface light source device as claimed in claim 1, wherein the LGP comprises a plurality of side surfaces interconnecting the emission surface and the bottom surface, and a plurality of reflective films coated on the side surfaces respectively.

13. A surface light source device comprising:
a plurality of light sources for emitting light beams; and
a light guide plate (LGP) for transmitting the light beams, comprising:
at least one light incident surface for receiving the light beams;
an emission surface adjacent to said light incident surface for emitting the light beams;
a bottom surface opposite to the emission surface;
a plurality of side surfaces between the emission surface and the bottom surface; and
a plurality of diffusion units formed on the bottom surface for scattering the light beams;
wherein an area of each diffusion unit is proportional to the sum of reciprocals of squares of distances between the diffusion unit and each of the light sources, and the sum of reciprocals of squares of distances between the diffusion unit and corresponding images of each of the light sources formed respectively by the side surfaces.

14. The surface light source device as claimed in claim 13, wherein a radius R of each diffusion unit is represented by the following equation:
$$R = {r}_{0} + k \sqrt{ \begin{matrix}{\sum }_{h = 1}^{w - m} {\sum }_{j = 1}^{m} {\sum }_{i = 1}^{{n}_{i}} {f}_{h} \frac{1}{{( X - {X}_{hji} )}^{2} + {( Y - {Y}_{hji} )}^{2}} + \\ {\sum }_{j = 1}^{m} {\sum }_{i = 1}^{{n}_{j}} \frac{1}{{( X - {X}_{ji} )}^{2}} + {( Y - {Y}_{ji} )}^{2}\end{matrix} }$$
wherein (X, Y), (Xⱼᵢ, Yⱼᵢ) and (Xₕⱼᵢ, Yₕⱼᵢ) respectively designate coordinates of the diffusion units, the light sources, and the images of the light sources in a Cartesian coordinate system; w designates the number of side surfaces, m designates the number of said light incident surfaces; nⱼ designates the number of light sources; fₕ designates the reflectivity of a corresponding side surface; i and j each designate the series of integers 1, 2, 3, . . . ; h designates a positive integer; and r₀ and k are constants whose values are related to predetermined specifications of the LGP and the light sources and the locations of the light sources.

15. The surface light source device as claimed in claim 13, further comprising a plurality of reflective films coated on the side surfaces of the LGP respectively.

16. A surface light source device comprising:
at least one light sources for directly emitting light beams; and
a light guide plate (LGP) for transmitting the light beams, comprising:
a light incident surface for receiving the light beams;
an emission surface adjacent to the light incident surface for emitting the light beams;
a plurality of side reflection surfaces laterally facing the incident surface and reflecting the light beams in the light guide plate;
a bottom surface opposite to the emission surface; and
a plurality of diffusion regions formed on the bottom surface for scattering the light beams;
wherein an area of each of said diffusion regions is inversely proportional to the sum of squares of distances between the diffusion regions and all light beams directly derived from either the light source or the side reflection surfaces.

17. The surface light source device as claimed in claim 16, wherein said each of said diffusion regions is essentially a single diffusion dot rather than a group of diffusion dots.
